(19) United States
(12) Patent Application Publication
(10) Pub. No.: US 2004/0107733 A1
(43) Pub. Date: Jun. 10, 2004

(54) Method and apparatus for forcedly cooling sheet glass and tempered sheet glass

(76) Inventor: Hideo Yashizawa, Osaka (JP)

Correspondence Address: MERCHANT & GOULD PC, P.O. BOX 2903, MINNEAPOLIS, MN, 55402-0903, US

(21) Appl. No.: 10/466,037

(22) PCT Filed: Jan. 18, 2002
(86) PCT No.: PCT/JP02/00303

(30) Foreign Application Priority Data
Jan. 18, 2001 (JP) 2001-010857

(51) Int. Cl. C03B 27/016

(52) U.S. Cl. 65/348; 65/114; 65/116

(57) ABSTRACT

A method for forcedly cooling sheet glass includes the step of causing water-cotaining members (11,31) to contact with both surfaces of sheet glass (27) to cool the sheet glass. Sheet glass heated to a predetermined temperrature is brought into contact with water-containing members to thereby quench the surface of the sheet glass. Water in the water-containing members partly evaporates owing to the heat of the sheet glass, and the sheet glass is thereby effectively cooled by the heat of evaporation of water.

### TECHNICAL FIELD

The present invention relates to a technique for tempering sheet glass.

### BACKGROUND ART

Heretofore, physically strengthened glass is produced chiefly by “thermal tempering employing air quenching” in which sheet glass is heated to around its softening point (e.g., 650° C.) and then blown with air to quench its surface to thereby form a compressive layer on the surface.

As for vehicular windshields, there is an increased demand for thin sheet glass to meet the recent requirement for vehicles to be light in weight. The thickness of thin sheet glass desired in the art is at most 3.0 mm or less, and such thin sheet glass could hardly have a temperature difference between the center and the surface thereof upon air cooling. Therefore, the conventional rapid quenching process for thin sheet glass is limited even though the speed of the cooling air and the quantity of the latter are increased.

Another tempering method is proposed, for example, in Japanese Patent No. 2,766,355 entitled “Apparatus for Bending and Quenching Sheet Glass”, which discloses a technique of solid contact cooling method. The solid contact cooling method is as follows: one surface of a solid convex mold is covered with an air-pervious surface member, and air is led into the mold through an air inlet while leading outside through an air outlet; therefore, cooling air is all the time applied to the back of the air-pervious surface member while a slight amount of air is jetted into the mold via the air-pervious surface member put thereon. The same air supply mechanism applies also to the other solid concave mold. Sheet glass to be processed is held between the convex mold and the concave mold and is forcedly cooled in that state. In the method, however, the cooling ability of the air that passes through the air-pervious member is low, and therefore the solid contact cooling action of the air-pervious surface member itself contributes essentially to cooling the sheet glass.

Furthermore, another tempering method is a water mist cooling method disclosed in, for example, Japanese Patent Laid-Open Publication No. SHO-58-190832 entitled “Method for Tempering Sheet Glass” and Japanese Patent Laid-Open Publication No. SHO-61-58827 entitled “Method for Producing Tempered Glass Lids”.

According to the solid contact cooling method mentioned above, the sheet glass to be processed could not be brought into uniform contact with the air-pervious member, that is, some part of the sheet glass will be brought into strong contact with the air-pervious member, but some other thereof will be brought into weak contact with, and still some other thereof could not be brought into contact with it owing to a gap therebetween. This is because the surface of the sheet glass could not be uniformly held against the air-pervious member, and therefore, the degree of contact between the sheet glass and the air-pervious member varies as mentioned above. The uneven contact causes uneven cooling of the sheet glass, and, as a result, the processed sheet glass will be unevenly tempered. For enhancing the ability of the sheet glass to follow the air-pervious member, if the thickness of the air-pervious member is increased, the thermal conductivity thereof will be lowered and the cooling ability thereof will therefore be lowered.

On the other hand, the water mist cooling method is also problematic in the following points. If the size of the water mists in the method is too small, the cooling performance in the method could not be increased. On the other hand, if the size of the water mists therein is too large, the part of glass having received the water mists will be strongly cooled and will be thereby cracked; while the other part thereof not having received them will be cooled little. As a result, the glass will be unevenly cooled, and will be therefore unevenly tempered. For these reasons, the size control of the water mists in the water-mist cooling method is extremely difficult.

In addition, thermally tempered glass requires a high-power, large-capacity blower for the necessary cooling performance, which, however, is problematic in point of the equipment as the power rates increase and the blower noise increases. Further, the water mist cooling method is also problematic in that operation control is difficult to perform, thus requiring an expensive control device.

### DISCLOSURE OF THE INVENTION

The present invention provides a novel, forced cooling technique suitable for quenching and tempering sheet glass and substitutable for the conventional thermal tempering employing air quenching, the solid contact cooling method and the water mist cooling method.

According to a first aspect of the present invention, there is provided a method for forcedly cooling sheet glass, which comprises the steps of preparing sheet glass heated to a predetermined temperature, preparing water-containing members by infiltrating water thereinto, and causing the water-containing members to contact both surfaces of the sheet glass to thereby cool the sheet glass.

As in the above, the method comprises applying water-containing members such as dusters suitably wetted with water to sheet glass to thereby quench the surface of the sheet glass. In this method, water in the water-containing members partly evaporates owing to the heat of the sheet glass, and the sheet glass is thereby effectively cooled by the heat of evaporation (this is the sum of the latent heat and the sensible heat) of that water. As a result, even thin sheet glass that may hardly have a temperature difference between the center and the surface thereof while quenched can be effectively tempered in the method of the invention.

According to a second aspect of the present invention, there is provided an apparatus for forcedly cooling sheet glass taken out of a heating furnace, which comprises an upper water-containing member and a lower water-retentive member for holding the sheet glass substantially horizontally therebetween, the upper water-containing member and the water-retentive member being formed from a material capable of absorbing and retaining water therein, an upper water supply unit for supplying water to the upper water-retentive member, and a lower water supply unit for supplying water to the lower water-retentive member.

In the cooling apparatus, sheet glass to be processed is held between the upper water-retentive member and the lower water-retentive member, both wetted with water, and is thereby forcedly cooled by them. The upper water supply unit and the lower water supply unit act to supply water to the upper water-retentive member and the lower water-retentive member, respectively. The two water-retentive members wetted with water such as dusters suitably wetted with water are applied to sheet glass, and the surface of the sheet glass in that condition is thereby quenched by them. Accordingly, water in the water-containing member partly evaporates owing to the heat of the sheet glass, and the sheet glass is thereby effectively cooled by the heat of evaporation of that water. As a result, even thin sheet glass that may hardly have a temperature difference between the center and the surface thereof while quenched can be effectively tempered in the apparatus of the invention.

The upper water-retentive member may be an upper belt, while the lower water-retentive member may be a lower belt. Sheet glass is cooled while it is held between the upper and lower belts. In the embodiments illustrated, the belts may be circulating endless belts, between which sheet glass may be cooled while being horizontally moved, and the productivity in the apparatus is easy to increase.

Desirably, the forced cooling apparatus further comprises an upper water vapor spray nozzle for spraying water vapor on the upper belt before the upper belt moved past the upper water supply unit reaches the sheet glass to be contacted with, and a lower water vapor spray nozzle for spraying water vapor on the lower belt before the lower belt moved past the lower water supply unit reaches the sheet glass to be contacted with. In this arrangement, water vapor is sprayed on the upper and lower belts via the upper and lower water vapor spray nozzles to thereby elevate the temperature of the water that the belts contain. If sheet glass heated to a high temperature is directly contacted with cold water, it will be cracked owing to thermal shock. To evade the trouble, water to be applied to the heated sheet glass is previously warmed up. The thermal shock referred to herein is meant to indicate that sheet glass to be quenched often receives surface tensile tension that exceeds its mechanical strength, and is thereby broken or cracked in the quenching process.

It is preferred that the upper water supply unit comprises an upper water tank in which the upper belt is dipped, while the lower water supply unit comprises a lower water tank in which the lower belt is dipped. The upper and lower belts are dipped in the upper and lower water tanks, respectively, and they therefore absorb water. The upper and lower water tanks may have a simple structure, and the upper and lower water supply units for use herein can be constructed at low costs.

Preferably, the forced cooling apparatus further comprises excess water remover units for removing excess water from the upper belt led out of the upper water tank and from the lower belt led out of the lower water tank. In this way, the upper and lower belts having been led out of the upper and lower water tanks, respectively, are separately passed through the respective excess water remover units whereby their water content is controlled to a suitable degree.

It is desired that the upper water supply unit comprises a water-dropping duct for supplying water mists to the upper surface of the upper belt. Since the upper belt travels along with the sheet glass being processed below it, the water therein evaporates in time and, as a result, the water content of the upper belt decreases and the cooling capability thereof also decreases. To solve the problem, water is dropped onto the upper belt through the water-dropping duct so as to supply water to the upper belt.

It is also desired that the lower water supply unit comprises a water spray nozzle for spraying water onto the lower surface of the lower belt. Since the lower belt also travels along with the sheet glass being processed on it, the water therein evaporates in time and, as a result, the water content of the lower belt decreases and the cooling capability thereof also decreases. To solve the problem, water is sprayed on the lower belt through the water spray nozzle so as to supply water to the lower belt.

Preferably, the upper belt is held against an upper surface of the sheet glass through an upper abutting member having a multiplicity of holes, the upper abutting member being of hollow structure and designed to serve as an upper degassing unit, so that the vapor generated during cooling of the sheet glass is discharged outside via the holes of the upper abutting member, while the lower belt is held against a lower surface of the sheet glass through a lower abutting member having a multiplicity of holes, the lower abutting member being of hollow structure and designed to serve as a lower degassing unit, so that the vapor generated during cooling of the sheet glass is discharged outside via the holes of the lower abutting member. If the generated vapor remains in the apparatus and covers the surroundings around the sheet glass, without being discharged outside, it will interfere with the cooling operation and will retard the cooling performance of the apparatus. To solve the problem, therefore, the generated vapor is made to be rapidly discharged out to thereby ensure the predetermined cooling operation. Concretely, the vapor generated around the upper and lower surfaces of the sheet glass is immediately discharged outside through the large number of holes formed in the upper and lower abutting members, via the degassing units separately connected to the abutting members. Accordingly, in the invention, the vapor generated in the apparatus can be rapidly discharged outside and the forced cooling operation can be well continued in good condition.

According to a third aspect of the invention, there is provided tempered sheet glass which is obtained by heating sheet glass to a predetermined temperature, followed by causing the sheet glass to contact with water-containing members.

As sheet glass is cooled by causing it to contact with a water-containing member, tempered sheet glass subjected to an appropriate cooling process can be obtained. With the tempered, thin sheet glass resulted from the appropriate cooling process, there are provided lightweight windshields for vehicles.

### BRIEF DESCRIPTION OF THE DRAWINGS

Certain preferred embodiments of the present invention will be described in detail below, byway of example only, with reference to the accompanying drawings, in which:

FIG. 1 is a cross-sectional view showing an apparatus for forcedly cooling sheet glass according to a first embodiment of the present invention;

FIG. 2 is an enlarged view showing one example of water vapor discharge and water supply illustrated in FIG. 1;

FIG. 3A shows air spray nozzles and a water vapor spray nozzle illustrated in FIG. 1;

FIG. 3B to FIG. 3D show parts b, c and d, respectively, of the upper belt of FIG. 3A;

FIG. 4 shows another embodiment of the excess water remover unit illustrated in FIG. 1;

FIG. 5 shows an apparatus for forcedly cooling sheet glass according to a second embodiment of the present invention; and

FIG. 6 shows an apparatus for forcedly cooling sheet glass according to a third embodiment of the present invention.

### BEST MODE FOR CARRYING OUT THE INVENTION

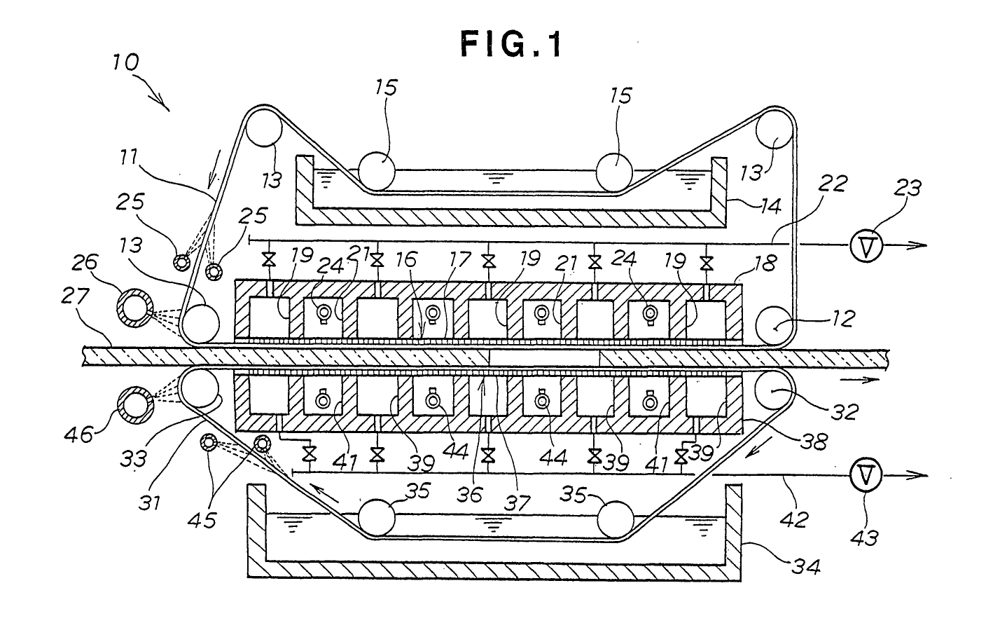

In FIG. 1, there is shown a sheet glass forced cooling apparatus 10 according to a first embodiment of the present invention. Sheet glass 27 is forcedly cooled while it is held between an upper belt 11, serving as an upper water-containing member, and a lower belt 31, serving as a lower water-containing member, and conveyed in an arrowed direction.

The upper belt 11 is driven by the upper driving roll 12, and is rotated via upper guide rolls 13. The upper water supply unit, upper water tank 14 is disposed along the direction in which the upper belt travels. Guide rolls 15 in water in the upper water tank 14 are to guide the upper belt 11 into the water in the tank 14. The upper abutting member 16 brings the upper belt 11 into contact with the upper surface of the sheet glass 27. The upper abutting member 16 is made of a porous plate having a large number of holes 17 therein. The-upper unit 18 is integrated in the upper abutting member 16. The upper unit 18 is partitioned into a plurality of alternate degassing chambers 19 and many moisturizing chambers 21 that are alternately disposed therein. The degassing chambers 19 are all connected to the vent pipe 22. The vent pipe 22 is connected to the upper degassing unit, suction blower 23. Every moisturizing chamber 21 has a water-dropping duct 24 disposed therein. The air spray nozzles 25, 25 are excess water remover units for removing the excess water from the upper belt 11. The upper water vapor spray nozzle 26 is to spray water vapor on the upper belt 11.

The lower belt 31 is driven by the lower drive roll 32, and is rotated via lower guide rolls 33. The lower water supply unit, lower water tank 34 is disposed along the direction in which the lower belt 31 travels. Many guide rolls 35 in water in the lower water tank 34 are to guide the lower belt 31 into the water in the tank 34. The lower abutting member 36 supports the lower surface of the lower belt 31 so as to make the lower belt 31 kept in contact with the lower surface of the sheet glass 27. The lower abutting member 36 is made of a porous plate having a large number of holes 37 therein. The lower unit 38 is integrated in the lower abutting member 36. The lower unit 38 is partitioned in to alternate degassing chambers 39 and moisturizing chambers 41 that are alternately disposed therein. The degassing chambers 39 are all connected to the vent pipe 42. The vent pipe 42 is connected to the lower degassing unit, suction blower 43. Every moisturizing chamber 41 has a water spray nozzle 44 disposed therein. The air spray nozzles 45, 45 are excess water remover units for removing the excess water from the lower belt 31. The lower water vapor spray nozzle 46 is for spraying water vapor onto the lower belt 31.

Not limited to suction blowers 23, 43 only, the upper and lower degassing units may also be any of ejectors or vacuum pumps.

The upper and lower belts 11, 31 may be made of any of felts, woven fabrics or meshes of a heat-resistant material. For the heat-resistant material for these, preferred are organic fibers such as represented by aramid fibers, metal fibers such as represented by stainless steel fibers, and ceramic fibers such as represented by glass fibers.

Thicker felts are favorable for more uniformly cooling the sheet glass being processed herein, and increases the initial water content thereof to a higher degree. For effectively discharging the water vapor to be generated through contact with glass, thinner felts are more preferred for the belts. As receiving great tension in a drive direction while being driven, the belts may preferably be base canvas-reinforced felts.

The belts may also be plain-woven or twill-woven fabrics which have a small rate of extension in a drive direction thereof. The weave texture of the woven fabrics shall be determined in consideration of the cooling uniformity and water retentiveness thereof.

In the case of the meshes, mesh patterns may be selected with consideration given to the cooling uniformity and water retentiveness thereof. When the tensioning applied to the belts while running is taken into consideration, the belts may desirably be a hybrid one formed of the meshes and the felts.

In FIG. 1, the upper and lower drive rolls 12, 32 are rotated by some driving sources (e.g., motors, but not shown), whereby the upper belt 11 is circulated counterclockwise in the illustration and the lower belt 31 is circulated clockwise therein. While the upper and lower belts 11, 31 are thus dipped in water in the upper and lower water tanks 14, 34, respectively, they are cooled therein and absorb water. With that, they pass between the air spray nozzles 25, 25, 45, 45, and by the upper and lower water vapor spray nozzles 26, 46 (their functions will be described herein under), and then pass between the upper and lower abutting members 16, 36 along with the sheet glass 27 sandwiched between them. In this process, the sheet glass 27 is forcedly cooled by the water-containing upper and lower belts 11, 31.

The upper and lower water tanks 14, 34 have the function of cooling the upper and lower belts 11, 31 that have absorbed heat and have been heated, to thereby restore the belts to their original condition. Specifically, the function of the tanks is that they cool the upper and lower belts 11, 31 to a predetermined temperature while giving them plenty of water necessary for cooling the belts. With that, the upper and lower belts 11, 31 start to forcedly cool the sheet glass 27 that is in the predetermined original condition.

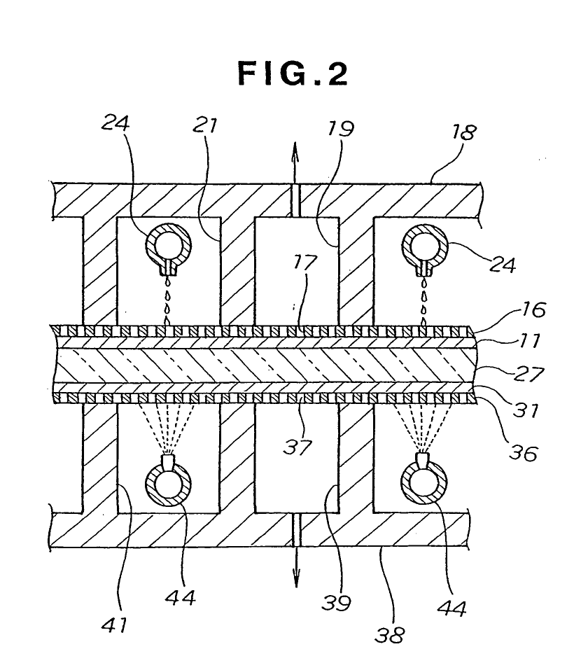

FIG. 2 is an enlarged cross-sectional view showing a part of the upper and lower units 18, 38. A part of water absorbed by the upper and lower belts 11, 31 evaporates and takes away the heat from the upper and lower surfaces of the sheet glass 27. The water vapor thus generated is discharged out of the units 18, 38 through the holes 17, 37 and through the degassing chambers 19, 39, as in the arrowed direction. Accordingly, there is no risk of some excess water vapor remaining on the upper and lower surfaces of the sheet glass 27. If, contrary to this, some excess water vapor remains thereon, it will form a heat-insulating layer that interferes with heat conduction, and, if so, the apparatus could not enjoy the intended cooling performance. Forcedly removing the water vapor as herein enables the apparatus to well continue the desired forced cooling of the sheet glass 27.

In this embodiment, the water vapor is discharged outside in the upper or lower direction through the degassing chambers 19, 39. Apart from this, it may also be discharged outside in the front or back direction in the illustration. The degassing chambers 19, 39 may be those in which the internal pressure is kept strictly negative (that is, reduced pressure lower than atmospheric pressure), but may also be those that merely act as exhaust passageways.

Through water evaporation from them, the water content of the upper and lower belts 11, 31 decreases. Therefore, water is supplied to the upper belt 11 through the water-dropping ducts 24, 24, and to the lower belt 31 through the water spray nozzles 44, 44. This ensures continuous forced cooling of the sheet glass in good condition in the apparatus.

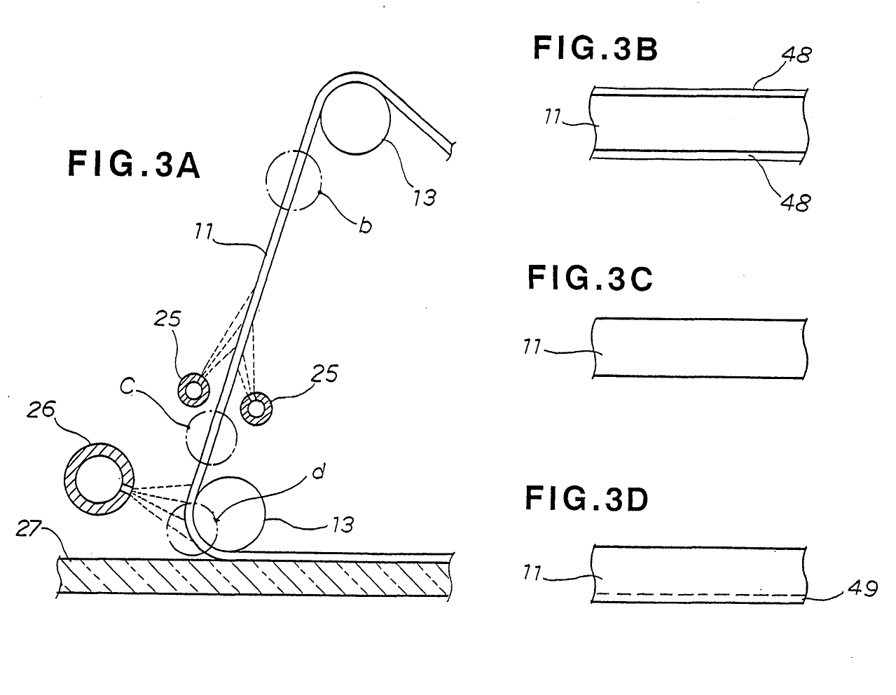

FIG. 3A shows the air spray nozzles 25, 25 and the upper water vapor spray nozzle 26 in the apparatus of FIG. 1; and FIG. 3B to FIG. 3D show the parts b, c and d, respectively, of the upper belt 11 of FIG. 3A.

As in FIG. 3A, high-pressure air is jetted toward the upper belt 11 through the air spray nozzles 25, 25. Next, high-temperature saturated water vapor (preferably, supersaturated water vapor) is sprayed on the upper belt 11 through the upper water vapor spray nozzle 26.

The site b shown in FIG. 3A corresponds to the belt just after passed through the water tank. As in FIG. 3B, excess water 48, 48 adheres to the upper and lower surfaces of the upper belt 11. The excess water 48, if brought into direct contact with the sheet glass 27, is unfavorable as the sheet glass will undergo thermal shock. Therefore, the excess water 48, 48 is blown away by high-pressure air.

FIG. 3C shows the upper belt 11 from which the excess water 48, 48 has been removed.

In the site d in FIG. 3A, water vapor is jetted toward the upper belt 11. Since the water vapor is at a high temperature, it forms a high-temperature hot water layer 49 in and around the center of one surface of the belt, as in FIG. 3D. The hot water layer 49 is brought into contact with the high-temperature sheet glass 27 to thereby completely prevent the sheet glass from undergoing thermal shock.

In the invention, the water vapor spray nozzle 26 may be changed to a hot air spray nozzle with no problem. When the hot air spray nozzle is used herein, the air spray nozzles 25, 25 may be omitted. Concretely, the hot air spray nozzle, if used, acts to remove the excess water 48, 48 and to form the hot water layer 49.

As described hereinabove, in the embodiment of FIG. 1, the upper and lower belts 11, 31 that are suitably wetted are kept in contact with the upper and lower surfaces of the sheet glass 27 to thereby forcedly cool the sheet glass 27 while water in the upper and lower belts 11, 31 is evaporated away. Since the heat of absorption by water is far larger than that by air, the surface temperature of the sheet glass 27, even though thin, can be well lowered than the inner temperature thereof, and, as a result, the intended tempered glass can be obtained in the method of the invention. As being endlessly circulated, the upper and lower belts are made of a flexible material. As a result, even when the surface of the sheet glass 27 is roughened, the sheet glass 27 can well follow the upper and lower belts 11, 31 while kept in contact with them.

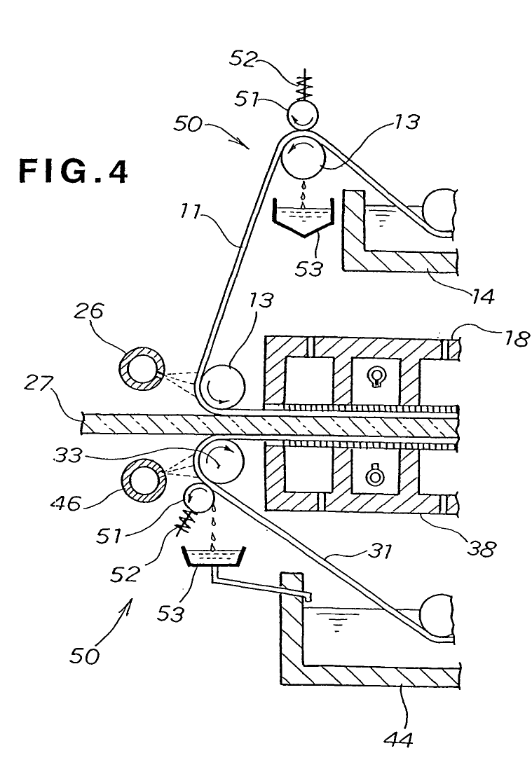

FIG. 4 shows another example of the excess water remover unit in the embodiment of FIG. 1. In FIG. 4, the same members as those in FIG. 1 are designated by the same numeral references, and their description is omitted herein.

The excess water remover unit 50 comprises pinch rolls 51, elastic members 52 that press the pinch rolls 51 against the guide rolls 13, 33, and water receiver pans 53; and its working principle is to squeeze the excess water from the upper and lower belts 11, 31. The system of jetting high-pressure air toward the belts through the air spray nozzle as in FIG. 1 and FIG. 3 requires a compressor, a pump and a high-pressure blower for generating high-pressure air. In this respect, the system of FIG. 4 that comprises the pinch rolls 51 and the elastic members 52 such as springs is advantageous, as not requiring such high-pressure air-generating units. Another advantage of the system of FIG. 4 is that the degree of excess water removal can be readily controlled merely by changing the pressing force of the elastic members 52 and easy to use.

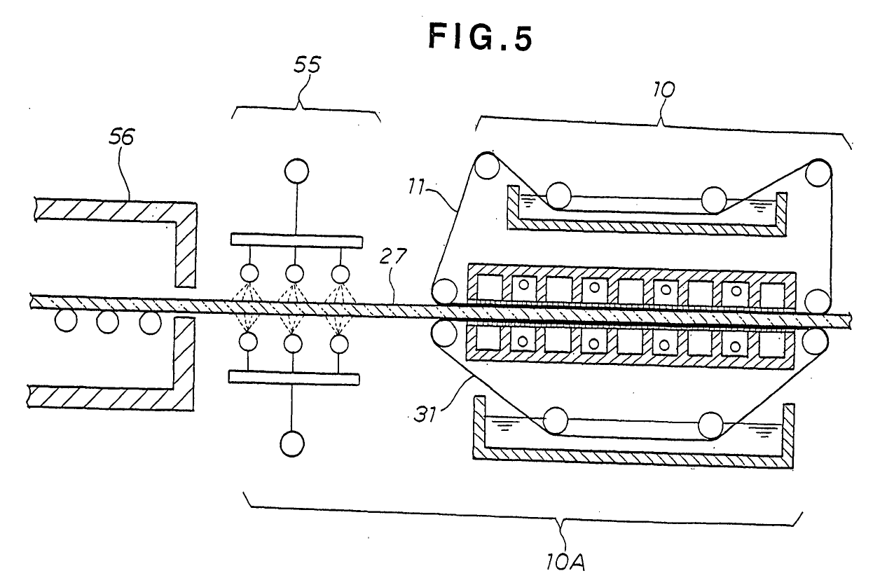

FIG. 5 shows an apparatus for forcedly cooling sheet glass in the second embodiment of the invention. The forced cooling apparatus 10A for sheet glass of this second embodiment comprises a combination of an air-cooling device 55 and the forced cooling device 10 of FIG. 1 connected in series. In this, the sheet glass 27 having gone out of the heating furnace 56 wherein it is heated to a predetermined temperature is first pre-cooled by quench air in an air quenching thermal tempering process (this is primary cooling), and then further cooled with water-containing members in a water-containing member contact cooling method (this is secondary cooling).

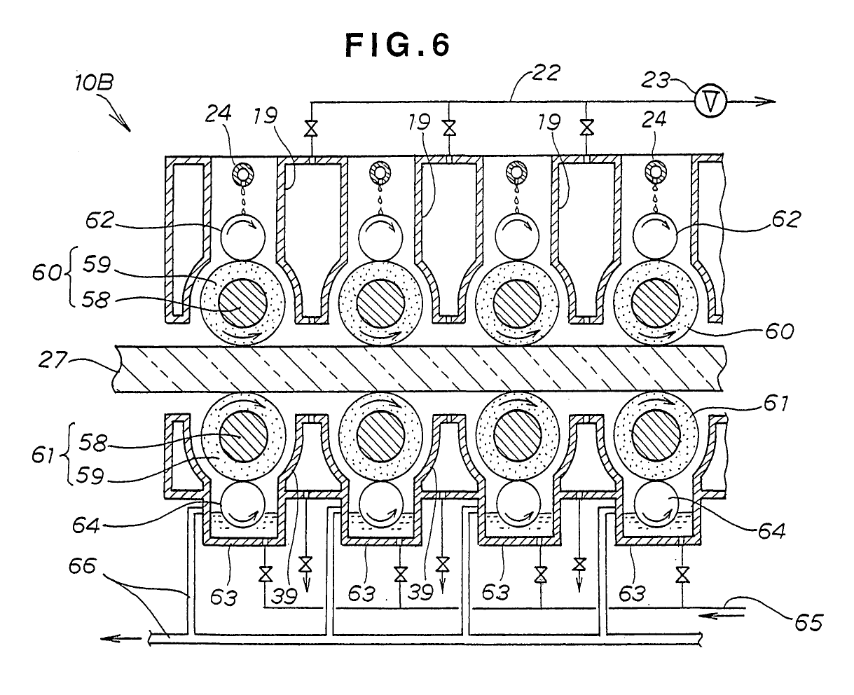

FIG. 6 shows an apparatus for forcedly cooling sheet glass in the third embodiment of the-invention. In this forced cooling apparatus 10B, the upper and lower water-containing members comprise a number of upper and lower felt rolls 60, 61 each composed of a felt 59 wound around a shaft 58. Water drops from the respective water-dropping ducts 24 are applied to the upper felt rolls 60 via the respective intermediate rolls 62, and the water content of the upper felt rolls 60 is thereby suitably controlled. Below the sheet glass 27, disposed are lower small water tanks 63. Water in these lower small water tanks 63 is applied to the respective lower felt rolls 61 via the respective intermediate rolls 64, and the water content of the lower felt rolls 61 is thereby suitably controlled. The water vapor formed on the upper surface of the sheet glass 27 is forcedly discharged outside through the degassing chambers 19 disposed between the neighboring upper felt rolls 60, 60, and through the exhaust pipe 22 and the suction blower 23. The water vapor formed on the lower surface of the sheet glass 27 is forcedly discharged outside through the degassing chambers 39 disposed between the neighboring lower felt rolls 61, 61. Water is supplied to the lower small water tanks 63 through the water supply duct 65, and its overflow is taken out through the overflow duct 66. In that manner, the water level in every water tank is kept all the time constant.

If desired, the upper surface of the sheet glass 27 may be cooled with the upper belt 11 as in FIG. 1, while the lower surface thereof is cooled with the lower felt rolls 61; or the lower surface of the sheet glass may be cooled with the lower belt 31 as in FIG. 1, while the upper surface thereof is cooled with the upper felt rolls 60.

The systems 10, 10A and 10B of the invention mentioned above all ensure far higher cooling performance as compared with ordinary air-cooling methods or solid contact cooling methods. In these systems, therefore, even thin sheet glass having a thickness of at most 3.0 mm or less can be well tempered. Specifically, according to the water-containing member contact cooling method of the invention, even such thin sheet glass having a thickness of at most 3.0 mm can be well processed to produce tempered glass. In addition, the invention is also favorable even to the production of tempered sheet glass that is thicker than 3.0 mm and is therefore readily processed in an ordinary thermal tempering method. As compared with the ordinary thermal tempering apparatus, the apparatus of the invention is advantageous as it is compact and its running costs are low.

With the inventive apparatus arranged as explained above, it is possible to impart high level of toughness to sheet glass having a thickness larger than 3.0 mm.

In addition, the inventive arrangements do away with noise sources such as blowers that produce actuation sounds and nozzles that produce air jetting sounds.

### Industrial Applicability

Tempered, thin sheet glass of high quality is obtained, and it is useful, for example, for vehicular windshields that are required to be lightweight.

1. A method for forcedly cooling sheet glass (27), comprising the steps of:
heating sheet glass to a predetermined temperature;
infiltrating water into solid water-retentive members (11, 31); and
causing the water-retentive members to simultaneously contact both surfaces of the sheet glass to thereby cool the sheet glass.

2. An apparatus for forcedly cooling sheet glass (27) taken out of a heating furnace (56), comprising;
an upper water-retentive member (11) and a lower water-retentive member (31) for holding the sheet glass therebetween, said upper and lower water-retentive members being formed from a material capable of absorbing and retaining water therein;
an upper water supply unit (14) for supplying water to the upper water-retentive member; and
a lower water supply unit (34) for supplying water to the lower water-retentive member.

3. The forcedly cooling apparatus as defined in claim 2, wherein the upper water-retentive member comprises an upper belt (11), and the lower water-retentive member comprises a lower belt (31).

4. The forced cooling apparatus as defined in claim 3, further comprising an upper water vapor spray nozzle (26) for spraying water vapor on the upper belt (11) before the upper belt moved past the upper water supply unit (14) reaches the sheet glass (27) to be contacted with, and a lower water vapor spray nozzle (46) for spraying water vapor on the lower belt (31) before the lower belt moved past the lower water supply unit (34) reaches the sheet glass to be contacted with.

5. The forced cooling apparatus as defined in claim 3, wherein the upper water supply unit comprises an upper water tank (14) in which the upper belt is dipped into water therein, and the lower water supply unit comprises a lower water tank (34) in which the lower belt is dipped into water therein.

6. The forced cooling apparatus as defined in claim 5, further comprising excess water remover units (25, 25, 45, 45) for removing excess water (48) from the upper belt (11) led out of the upper water tank (14) and from the lower belt (31) led out of the lower water tank (34).

7. The forced cooling apparatus as defined in claim 3, wherein the upper water supply unit comprises water-dropping ducts (24) for applying water drops onto an upper surface of the upper belt (11).

8. The forced cooling apparatus as defined in claim 3, wherein the lower water supply unit comprises water spray nozzles (44) for spraying water onto the lower surface of the lower belt (31).

9. The forced cooling apparatus as defined in claim 3, wherein the upper belt (11) is held against am upper surface of the sheet glass (27) via an upper abutting member (16) having a multiplicity of holes (17), the upper abutting member being of hollow structure and designed to serve as an upper degassing unit (23), so that the vapor generated during cooling of the sheet glass is discharged outside via the holes of the upper abutting member, and wherein the lower belt (31) is held against a lower surface of the sheet glass through a lower abutting member (36) having a multiplicity of holes (37), the lower abutting member being of hollow structure and designed to serve as a lower degassing unit (43), so that the vapor generated during cooling of the sheet glass is discharged outside via the holes of the lower abutting member.

10. Tempered sheet glass which is obtained by heating sheet glass to a predetermined temperature, followed by causing the sheet glass to contact with solid water-retentive members (11, 31, 59).
